(19) United States
(12) Patent Application Publication
(10) Pub. No.: US 2007/0086056 A1
(43) Pub. Date: Apr. 19, 2007

(54) METHOD OF IMAGE PROCESSING FOR HEAT ACCUMULATION OF A THERMAL PRINTER

(76) Inventor: Wen-Hung Hsieh, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/276,317

(22) Filed: Feb. 24, 2006

(30) Foreign Application Priority Data
Oct. 19, 2005 (TW) 094136548

(51) Int. Cl. H04N 1/40

(52) U.S. Cl. 358/3.01; 358/448

(57) ABSTRACT

A method of image processing for heat accumulation of a thermal printer refreshes grayscale output of printing pixels that lie in correction regions with smear phenomena caused by heat accumulation of a thermal printer. The actual grayscale output of the printing pixels of the correction regions is lower than the original grayscale output and the scale of correction of the grayscale output is gradually decreased to zero along the direction of printing. The method substantially eliminates the smear phenomena caused by heat accumulation and allows a thermal printer to provide better output.

### BACKGROUND OF THE INVENTION

1. Field of the Invention

The present invention relates to a method of image processing for heat accumulation, and more specifically, to a method of image processing for heat accumulation of a thermal printer.

2. Description of the Prior Art

Thermal printers are different from general printers. A major difference is that thermal printers print images, such as photo pictures, on paper with high picture quality. Please refer to FIG. 1, which is an illustration of a simplified exploded view of a prior art thermal printer 10. A thermal print head 12 has a plurality of heaters 22 that are arranged linearly and spaced equally for heating a ribbon 14. Colored dye stored on the ribbon 14 is heated, and is transferred onto the photo paper 16. When the thermal print head 12 starts printing images, each heater 22 positioned on the thermal print head 12 heats the ribbon 14 so that a plurality of corresponding pixels X1 will form a line image Y1. Photo paper 16 driven by a roller set is then moved along a predetermined direction at a predetermined speed. Another line image Y2 is then printed on the same photo paper 16 next to the line image Y1. Accordingly, a plurality of line images is printed on the same photo paper 16 to complete the printing operation.

As mentioned above, the total number of heaters 22 positioned on the thermal print head 12 determines the corresponding number of pixels X1 of each line image printed on the photo paper 16. Moreover, the color concentration, that is, the gray level of each pixel X1 printed on the photo paper 16, is determined by the corresponding heater 22, which has a specific heating temperature of each heating operation. A common image is composed of a plurality of pixels X1 with different gray levels. However, the actual output gray level of each pixel X1 can differ from the required gray level even when each corresponding heater 22 works properly according to the commands from the printer. This is because heat accumulation occurs on the thermal print head 12 during printing.

Please refer to FIG. 2, which illustrates the phenomenon of smear caused by heat accumulation of a prior art thermal printer 10. The thermal print head 12 transfers color dye of the ribbon 14 on the photo paper 16 by heating the ribbon 14, the higher the gray level of the color, the higher heating temperature required. Accordingly, taking for example zones Z1, Z3 with lower pixel gray level and a zone Z2 with higher pixel gray level on the photo paper 16, it takes lower heating temperature for printing the lower gray level zone Z1, and the heating temperature need only be raised for printing the following higher gray level zone Z2, which brings up a clear boundary L1 between zone Z1 and zone Z2. However, if the thermal print head 12 prints a lower gray level zone Z3 right after printing the higher gray level zone Z2, which needs higher temperature the heaters 22, the heaters 22 will transfer dye of the ribbon 14 onto zone Z3 with higher heating temperature than the needed heating temperature of the zone Z3. This is because the temperature of the heaters 22 cannot be reduced immediately to what the zone Z3 needs, resulting in the gray level output of a zone S of zone Z3 adjacent to zone Z2, ranging from boundary L2 to boundary L3, being higher than the original gray level output and returning to the original gray level output gradually along the direction of printing. This is the so-called phenomenon of smear caused by heat accumulation.

Because of heat accumulation of a thermal printer 10, the quality of output is inevitably degraded.

### SUMMARY OF THE INVENTION

The claimed invention provides a method of image processing for heat accumulation of a thermal printer. The method comprises generating a grayscale difference value of a target pixel according to grayscale values of a plurality of printing pixels before the target pixel and according to grayscale values of a plurality of printing pixels after the target pixel, and updating the grayscale values of the printing pixels after the target pixel according to the grayscale difference value of the target pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a simplified exploded view of a prior art thermal printer.

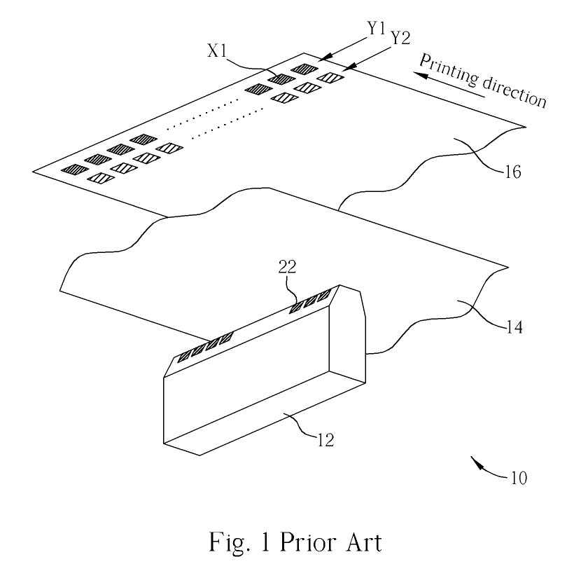

FIG. 2 illustrates the phenomenon of smear caused by heat accumulation of a prior art thermal printer.

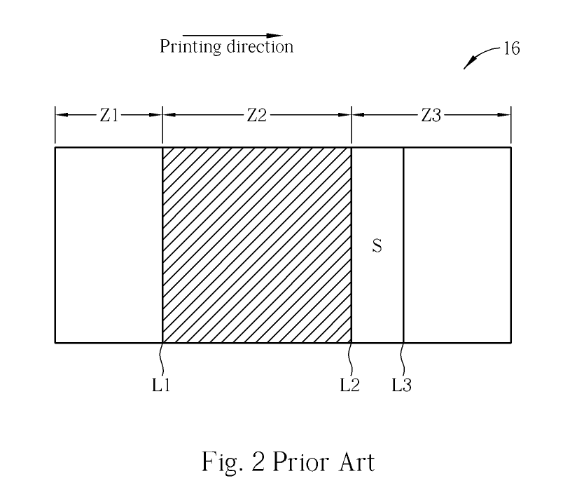

FIG. 3 is a flow chart showing a method of image processing for heat accumulation of a thermal printer according to the present invention.

FIG. 4 is a distribution curve plot of grayscale difference value according to each printing pixel P.

FIG. 5 is an illustration of updating grayscale values of a target pixel 0 and the following printing pixels P based on an empirical function.

### DETAILED DESCRIPTION

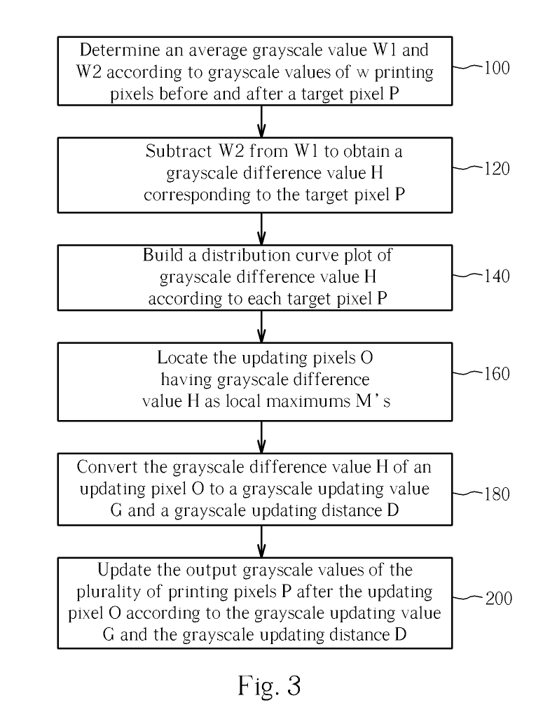

Please refer to FIG. 3, which is a flow chart referring to a method of image processing for heat accumulation of a thermal printer according to the present invention. The method includes steps as follows:

Step 100: determine an average grayscale value W1 according to grayscale values of w printing pixels before a target pixel P and an average grayscale value W2 according to grayscale values of w printing pixels after the target pixel P along the direction of printing, wherein w is an integer greater than 1 and is properly determined by experimentation;

Step 120: determine a grayscale difference value H corresponding to the target pixel P by subtracting W2 from W1 in Step 100; hence, H=W1−W2;

Step 140: repeat Step 100 and Step 120 until the grayscale difference values H according to all the target pixels P are acquired, then build a distribution curve plot of grayscale difference value H according to each target pixel P.

Step 160: in the distribution curve plot built in Step 140 and according to a plurality of successive target pixels P, locate one or more updating pixels 0 having grayscale difference value H as a local maximum M within the plurality of successive target pixels P;

Step 180: according to an experimental function, convert the grayscale difference value H of an updating pixel 0 to a grayscale updating value G and a grayscale updating distance D, where the grayscale updating distance D indicates the number of successive pixels P after the updating pixel 0 to receive updated grayscale values; and

Step 200: update the output grayscale values of the plurality of printing pixels P after the updating pixel 0 according to the grayscale updating value G and the grayscale updating distance D acquired in Step 180.

The method introduced in the present invention determines whether or not to deal with the problem of heat accumulation according to obvious grayscale change of a printing pixel P. As Step 100 and Step 120 describe, the grayscale change of the printing pixel P is determined by each grayscale distribution of w successive printing pixels before and after the printing pixel P. The grayscale difference value H is obtained by subtracting an average grayscale value W2 of w printing pixels after the printing pixel P from an average grayscale value W1 of w printing pixels before the printing pixel P, namely, H=W1−W2. H can be positive or negative. A positive grayscale difference value H means the grayscale of an area where the printing pixel P is located changes from high grayscale to low grayscale, whereas a negative grayscale difference value H means the grayscale of an area where the printing pixel P is located changes from low grayscale to high grayscale. The method according to the present invention deals with a printing pixel P with a positive grayscale difference value H where the problem of smear due to heat accumulation is to be solved. Furthermore, the greater the grayscale difference value H, the greater the change from high grayscale to low grayscale in the area where the printing pixel P is located, which means the more obvious a smear would be. In Step 140 a distribution curve plot of grayscale difference value H according to all target pixel P is then built.

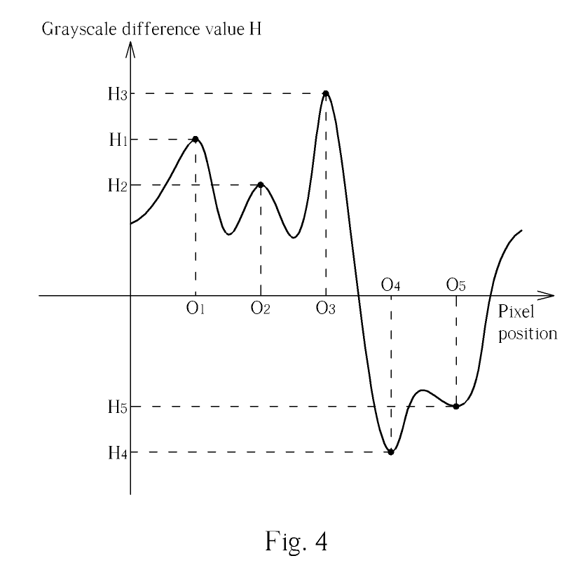

Please refer to FIG. 4, which is a distribution curve plot of grayscale difference value H according to each printing pixel P. Since each heater 22 of a thermal printer 10 prints a pixel (a printing pixel P) at a time, a heater 22 prints a plurality of pixels P on the photo paper 16 along the printing direction and a distribution curve plot in FIG. 4 can be built with regard to each heater 22. In order to easily implement the method according to the present invention, a preferred exemplary embodiment of the present invention deals with printing pixels P having a grayscale difference value H as a local maximum M together with its adjacent areas. In the distribution curve plot in FIG. 4, updating pixels O₁, O₂, and O₃, each having local maximum grayscale difference value H₁, H₂, and H₃, (updating pixels O₄ and O₅ are excluded because their grayscale difference values H₄ and H₅ are negative) and their following plurality of printing pixels are updated in grayscale.

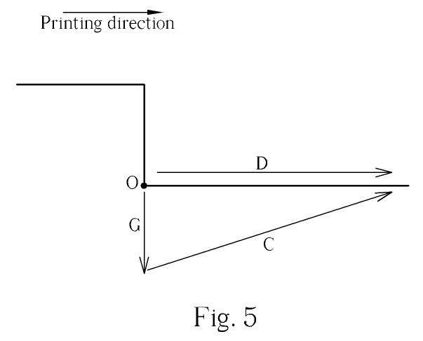

Please refer to FIG. 5, which is an illustration of updating the grayscale values of a target pixel 0 and the following printing pixels P based on an empirical function. When the updating pixels O₁, O₂, and O₃ and their corresponding grayscale difference values H₁, H₂, and H₃ are determined, each grayscale difference value H corresponding to each updating pixel is converted by an empirical function F(H) and grayscale updating value G and a grayscale updating distance D are generated in Step 180, wherein F(H)=(G,D). The preferred exemplary embodiment according to the present invention updates the grayscale of the updating pixels O₁, O₂, and O₃ and the following plurality of printing pixels P according to each updating pixel.

For example, the empirical function F(H) converts the grayscale difference value H₁ corresponding to the updating pixel 0, and generates an outcome according to F(H₁)=(G₁,D₁). When printing, the grayscale of the updating pixel O₁ is updated to a new grayscale that is less than the original grayscale by G₁ grayscale value, and the updated grayscale of the updating pixel O₁ is taken as an actual printing grayscale value. D₁ indicates the number of successive pixels P after the updating pixel O₁ to receive updated grayscale values. Therefore, grayscale of printing pixels between the updating pixel O₁ and the printing pixel O₁+D₁ are updated to actual printing grayscale. The way to update the grayscale of the plurality of printing pixels P between the updating pixel O₁ and the printing pixel O₁−D₁ is shown in FIG. 5. The updating pixel O₁ goes down by a value G₁ to a new grayscale output and the updating takes no effect on pixels after the printing pixel O₁+D₁. The amount of grayscale updating decreases progressively from G₁ in the updating pixel O₁ to 0 in the printing pixel O₁+D₁, as the curve C in FIG. 5 shows. The updating method is harmonized with the distance-dependent decrease of smear caused by heat accumulation. Updating pixels O₂ and O₃ are dealt with in the same way as the updating pixel O₁.

The method according to the present invention refreshes grayscale output of printing pixels that lie in correction regions to compensate for smear phenomena caused by heat accumulation of a thermal printer. The actual grayscale output of the printing pixels of the correction regions is lower than the original grayscale output and the scale of correction of the grayscale output is gradually decreased to zero along the direction of printing. The method substantially eliminates smear phenomena caused by heat accumulation and allows a thermal printer to provide better output.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of image processing for heat accumulation of a thermal printer, comprising:
generating a grayscale difference value of a target pixel according to grayscale values of a plurality of printing pixels before the target pixel and according to grayscale values of a plurality of printing pixels after the target pixel; and
updating the grayscale values of the printing pixels after the target pixel according to the grayscale difference value of the target pixel.

2. The method of claim 1 further comprising locating a target pixel having a local maximum grayscale difference value according to grayscale difference values of a plurality of successive target pixels.

3. The method of claim 1 wherein generating a grayscale difference value of a target pixel according to grayscale values of a plurality of printing pixels before the target pixel and according to grayscale values of a plurality of printing pixels after the target pixel comprises:
generating a first average grayscale value according to the grayscale values of the plurality of printing pixels before the target pixel;
generating a second average grayscale value according to the grayscale values of the plurality of printing pixels after the target pixel; and
generating the grayscale difference value according to the first average grayscale value and the second average grayscale value.

4. The method of claim 1 further comprising determining a number of pixels to receive updated grayscale values after the target pixel according to the grayscale difference value.
